(19) United States
(12) Patent Application Publication
(10) Pub. No.: US 2016/0310903 A1
(43) Pub. Date: Oct. 27, 2016

(54) Hollow Fiber Module, Fluid Treatment Device, and Method of Forming a Hollow Fiber Module

(71) Applicant: MANN+HUMMEL GMBH, Ludwigsburg (DE)

(72) Inventor: Stuart Miller, Clayton, NC (US)

(21) Appl. No.: 14/693,004

(22) Filed: Apr. 22, 2015

(51) Int. Cl. B01D 63/02; B01D 67/00

(52) U.S. Cl. CPC B01D 63/02; B01D 63/021; B01D 67/00; B01D 2319/04

(57) ABSTRACT

A hollow fiber module has elongate fiber sections formed to a bundle with a first end face. At least two elongate fiber sections are arranged side by side and provided with a first end and a second open end. The first ends are connected to each other by a looped fiber section to a one-piece fiber part. The second open ends are arranged at the first end face of the bundle. At least one fixing strip secures the second open ends. The hollow fiber module is made by placing elongate fiber sections side by side, securing the elongate fiber sections to a fixing strip, arranging the elongate fiber sections secured to the fixing strip as a bundle, and forming at least one hollow fiber within the bundle as one piece of at least two of the elongate fiber sections connected to each other by a looped fiber section.

### BACKGROUND OF THE INVENTION

The present invention relates to a hollow fiber module, in particular of a fluid treatment device, particularly of a fluid filtration unit or a humidifier, in particular of or for a fuel cell, with a plurality of fiber sections arranged as a bundle wherein on a first end face of the bundle open ends of at least two fiber sections are arranged side by side and fixed to at least one strip-like or tape-like fixing means.

The present invention further relates to a fluid treatment device, in particular of a fluid filtration unit or a humidifier, in particular of or for a fuel cell, comprising at least one hollow fiber module with a plurality of fiber sections arranged as a bundle wherein on a first end face of the bundle open ends of at least two fiber sections are arranged side by side and fixed to at least one strip-like or tape-like fixing means.

The present invention furthermore relates to a method of forming a hollow fiber module, in particular of a fluid treatment device, particularly of a fluid filtration unit or a humidifier, in particular of or for a fuel cell, comprising the steps of arranging a plurality of fiber sections side by side, fixing the fiber sections to at least one strip-like or tape-like fixing means each, arranging the fiber sections as a bundle.

EP 1 148 933 B1 discloses an array of hollow fiber membranes. The array is fabricated by winding a continuous length of hollow fiber membrane on a rotating mandrel having a circular cross section. The wound hollow fiber membrane is arranged in a single layer, with the windings being substantially parallel to one another either in contiguous contact with, or spaced uniformly apart from, one another. One or more strips of an adhesive tape are applied to the outer surface of the hollow fiber membrane segments positioned along the length of the mandrel in an orientation parallel to its axis of rotation and perpendicular to the central axes of the individual hollow fiber segments. A cutting guide may be used to slit the hollow fiber membrane segments along the middle of the entire length of the tape such that the hollow fiber membranes remain joined together by the now halved strip of tape. The next operation in the fabrication of a hollow fiber membrane module is the winding of the fiber array into a bundle and the corresponding formation of a pair of tube sheets at one or more of the edges of the array. An extruder is used to feed a thermoplastic sealing polymer to a dual slot extrusion die which produces two polymer extrusions in the form of a stream.

### SUMMARY OF THE INVENTION

It is an object of the invention to provide a hollow fiber module, a fluid treatment device, and a method of forming a hollow fiber module of the above-mentioned kind, wherein a production of the hollow fiber module can be simplified. In particular, a degree of automation of the production process is to be improved. Particularly, a hollow fiber module is to be produced in a continuous manner.

The object is achieved by the hollow fiber module in that, apart from their open ends, at least two fiber sections are connected by an appropriate looped fiber section and form together a one-piece (monolithic) member.

According to the invention, at least two fiber sections are connected by use of a looped fiber section to a one-piece member such that they realize a longer continuous fiber part. Said fiber part can be comprised of two fiber sections and one looped fiber section.

For realizing the bundle, a continuous length of a hollow fiber, in particular a hollow fiber membrane, can be laid back and forth across at least one fixing means, in particular a polymer backing strip. In this way, the length of the at least one fiber part can be increased without increasing the corresponding length of the bundle. The active surface of the at least one fiber part can be increased. The active surface is the surface through and/or along which a fluid can flow. The length of the fiber sections can depend on or can be adapted to a device, in particular a fluid treatment device, particular a housing depth, particularly a filter housing depth.

Advantageously, the at least one looped fiber section can be arranged on a second end face of the bundle. The second end face can be opposite to the first end face.

The two open ends of the at least one fiber part are arranged on the same end face of the bundle. So, a fluid connection to the fiber sections can be on the same side. Favorably, the first end face of the bundle can act as a fluid connection side. On the first end face, the interior of the fiber sections can be connected to an inlet or an outlet for fluid of the device, in particular of the fluid treatment device.

The open ends of the fiber sections are arranged side by side. The open ends can be arranged in a space-saving manner. At least two of the open ends can be in contiguous contact with, or spaced apart from, one another. The open ends can be spaced uniformly from another.

Advantageously, at least two fiber sections can be parallel at least in the area of their open ends.

The open ends of at least two elongate fiber sections are fixed to at least one strip-like or tape-like fixing means each. Thus, the open ends of the fiber sections can be held in their positions in particular during production of the hollow fiber module and/or mounting of the hollow fiber module in a housing of a device, particularly a device for fluid treatment.

Advantageously, the at least one fixing means can end on one side, particularly on one of its long sides, so as to be flush with the open ends of at least two fiber sections. Said side of the at least one fixing means can be aligned with the edges of the open ends of the respective fiber sections. In this way, the at least one fixing means can secure the fiber sections up to the edges of the respective open ends. Thus, the fixation and positioning of the open ends of the respective fiber sections can be further improved.

Advantageously, selection of the material of the at least one fixing means can depend upon or can be adapted to operating and/or environmental conditions of the hollow fiber module, in particular a product application and/or environment.

Advantageously, the at least one fixing means can at least partly be flexible. In this way, the at least one fixing means can be rolled, wound, bent or folded. Favorably, the arrangement of fiber sections can be rolled up, wound and/or folded to the bundle.

Advantageously, the fiber sections can be preassembled for potting, wherein the open ends can be positioned and fixed by the at least one tape in a correct position. The potting process can then be realized easier and more precisely.

Advantageously, at least one elongate fiber section and/or at least one looped fiber section can be a hollow fiber membrane. Favorably, the hollow fiber module can be realized as a hollow fiber membrane module.

Advantageously the invention can be used with various devices for treatment of gaseous and/or liquid fluids, in particular air and/or water. Particularly, the invention can be used for devices for a fluid filtration unit. It also can be used for humidifiers. Such humidifiers can be used in combination with fuel cells. Furthermore, the invention can be used in combination with engines, in particular electric motors or internal combustion engines. The invention also can be used in combination with vehicles.

According to a favorable embodiment of the invention, the at least one fixing means can comprise a polymer. A polymer can improve flexibility of the at least one fixing means. Further, a polymer can be handled easily, in particular formed easily.

Favorably, the at least one fixing means can be made of polymer. The at least one fixing means can be in the form of or can comprise at least one polymer tape or backing strip. The tape or backing strip can be thin compared to its length and/or width. Thus, the required space for the at least one fixing means can be reduced. Further, its mechanical flexibility can be improved.

According to a further favorable embodiment of the invention, the at least one fixing means can have at least one adhesive side. At least one fiber section can be easily fixed to the at least one adhesive side. At the adhesive side, the fiber sections can be held in place in the way they were laid.

Advantageously, the at least one fixing means can comprise a polymer tape or stripe with at least one adhesive side. In this way, a flexibility of the polymer tape can be combined with the adherence of the adhesive side.

Advantageously, the at least one fixing means can comprise at least one adhesive. Favorably, the at least one adhesive can be arranged on the adhesive side of the at least one fixing means.

According to a further favorable embodiment of the invention, the bundle can be rolled and/or wound and/or layered and/or folded to have an appropriate structure at least on its first end face. Thus, the bundle can be realized easily. Furthermore, a process for rolling and/or winding and/or layering and/or folding can be automated easily. Furthermore, such a process can be realized easily in a continuous manner.

According to a further favorable embodiment of the invention, the bundle can have a round, oval and/or angular, in particular rectangular, cross-section or shape at least on its first end face. With such cross-sections, a ratio of an external volume of the bundle to the number of fiber sections, in particular the total active surface of the fiber sections, can be improved. Favorably, the external volume can be decreased and/or the number of fiber sections can be increased.

A round or oval cross-section can be realized easily by rolling up or winding up the fiber sections and/or the at least one fixing means. An angular cross-section can be easily realized by layering and/or folding the fiber sections and/or the at least one fixing means.

According to a further favorable embodiment of the invention, on the first end face of the bundle at least one open end of at least one fiber section can be potted in potting material. With potting material, the fixation of the at least one open end of the at least one fiber section can be improved. Further, interstices between the fiber sections, in particular between the open ends, can be closed. Thus, a fluid flow in or through the interstices existing between the fiber sections at the end face of the bundle can be decreased, preferably prevented. Furthermore, potting material can act as a mounting means for attaching the bundle to a part, in particular housing, of the device, in particular the fluid treatment device.

Advantageously, the at least one fixing means can at least partly be potted in potting material. Mechanical stability of the bundle can thus be further improved.

Further, the object is achieved for the fluid treatment device in that, apart from their open ends, at least two elongate fiber sections are connected by an appropriate looped fiber section and form together a one-piece (monolithic) member.

The aforementioned advantages and characteristic features of the inventive hollow fiber module and of its favorable embodiments apply analogously to the inventive fluid treatment device and its favorable embodiments and vice versa.

Furthermore, the object is achieved for the method in that at least one hollow fiber is formed of at least two connected fiber sections connected by an appropriate looped fiber section and forming together a one-piece (monolithic) member.

The at least two fiber sections connected by a looped fiber section can easily be arranged in a continuous manner.

Favorably, adhesive, in particular adhesive beads, particularly small adhesive beads, can be placed on the at least one fixing means to keep the hollow fiber, in particular the fiber sections, attached and aligned on the at least one fixing means, particularly the polymer strip.

Advantageously, a material of the adhesive can be compatible with a possible final potting material, particular potting beads.

The length of the formed, in particular folded, hollow fiber can depend on the final bundle length needed for the application, in particular for an appropriate housing, particularly filter housing. The inventive method can be used to manufacture bundles with round, oval, or rectangular cross-sections.

Furthermore, the above-mentioned advantages and characteristic features of the inventive hollow fiber module and the inventive fluid treatment device and their favorable embodiments apply analogously to the inventive method and its favorable embodiments and vice versa.

According to a favorable embodiment of the invention, at least one hollow fiber can be laid with a back and forth folding pattern across at least one strip-like or tape-like fixing means.

So, a plurality of elongate fiber sections connected by looped fiber sections can easily be arranged, positioned, and fixed in a continuous manner.

According to a further favorable embodiment of the invention, at least one fixing means and at least one hollow fiber, in particular at least one fiber section, can be cut along the length of the at least one fixing means.

In this way, the arrangement of the hollow fiber positionally secured by use of the at least one fixing means can be cut into pieces. Thus, two sheets or bundles of fiber sections can be easily realized. Thereby, the fiber sections on both sides of a cutting line can be kept fixed by the respective parts of the at least one fixing means. Along the cutting line, the open ends of the fiber sections can be realized. Thereby, the long sides of the parts of the at least one fixing means are aligned with the edges of the open ends of the fiber sections.

According to a further favorable embodiment of the invention, at least one fiber section and at least one fixing means can be rolled and/or wound and/or layered to form the bundle.

Advantageously, at least one fiber section and at least one fixing means can be arranged as a bundle before cutting the at least one hollow fiber and the at least one fixing means. Thus, two bundle parts can be realized with one cutting process.

After the hollow fibers are laid and secured on the at least one fixing means, they can be rolled into a bundle. If applicable, potting material, particularly at least one adequate bead of potting material, can be dispensed prior to rolling. The hollow fiber sheet can be rolled in a direction away from the fibers into the bundle, in particular a round bundle. The at least one fixing means, in particular a polymer strip, can be continued around the bundle to form an outer band. During the rolling process, the possibly provided potting material can be dispensed onto the at least one fixing means.

The pressure which can be generated during the rolling process can distribute the possibly presented potting material across wide areas, particularly all areas, of the fibers. This can guarantee a complete seal at least on the end face of the bundle.

Oval shaped bundles can be realized by winding, similar to the way a compact filter element is produced, by starting with one or two long center strips of fixing means.

Rectangular shaped bundles can be created by stacking backed hollow fiber strips. Then the bundle can be wrapped with a continuous outer layer.

According to a further favorable embodiment of the invention, at least one open end of at least one fiber section can be potted in a potting material at least on a first end face of the bundle. Mechanical stability of the bundle at least on the potted end face can be improved in this way.

Advantageously, at least a part of at least one fixing means also can be potted in the potting material. Thus, mechanical stability of the bundle can be further improved.

Advantageously, the invention can be used for potting hollow fibers, particularly hollow fiber filter membranes.

Advantageously, after the potting material has hardened, the bundle can be cut into two pieces along a line, in particular a centerline, of the at least one fixing means, particular the backing strip. After the cutting step, the open fibers can be exposed. The bundle is ready to be installed and to seal in the housing, particularly filter housing.

In contrast to known current potting processes for hollow fibers, it is not required according to the invention that all of the fiber ends have to be placed into a cup and the potting material has to then be poured into the cup and cured. In the current potting processes, the cup end has then to be cut off for exposing the fiber openings.

The method according to the invention can easily be automated in series production. The process can be realized in a continuous manner. Batch processing steps are not required.

The fibers can be potted as the bundle is wound, similar to the way a compact filter element is made.

Furthermore, applications such as low cost water filtration units and fuel cell humidifiers can be realized with the invention.

The method according to the invention for forming a hollow fiber module, in particular the possible potting process, can maintain a good and even distribution of the fibers. Furthermore, the method can reduce leakage paths. In particular, the optional potting material can penetrate into areas where hollow fibers are touching.

Advantageously, the hollow fibers can be held in a uniform orientation on the at least one fixing means, particular a backing strip or tape so that, when wound, the hollow fibers can be very uniformly distributed. Also, the optional potting material can be controlled in a precise manner since it can be applied constantly during the winding process. This and the pressure created during the rolling and/or winding and/or folding process can also squeeze the potting material into all the existing voids thus providing a good seal relative to each fiber.

### BRIEF DESCRIPTION OF DRAWINGS

The present invention together with the aforementioned objects and other objects and advantages may best be understood from the following detailed description of the embodiments, but is not restricted to the embodiments.

FIG. 1 shows an isometric view of a hollow fiber membrane module according to a first embodiment with a round bundle comprising a plurality of fiber sections arranged in loops, wherein the open ends of the fiber sections are secured by a fixing tape and potted in a potting material.

FIG. 2 is a top view of the hollow fiber membrane module of FIG. 1.

FIG. 3 shows the hollow fiber membrane module of FIGS. 1 and 2 in an early production stage.

FIG. 4 shows the hollow fiber membrane module of FIGS. 1 to 3 during an advanced production stage.

FIG. 5 shows the hollow fiber membrane module of FIGS. 1 to 4 during a further advanced production stage.

FIG. 6 is a hollow fiber membrane module according to a second embodiment with a rectangular bundle of fiber sections.

In the drawings, same or similar elements are referred to by same reference numerals. The drawings are merely schematic representations and are not intended to portray specific parameters of the invention. Moreover, the drawings are intended to depict only typical embodiments of the invention and therefore should not be considered as limiting the scope of the invention.

### DESCRIPTION OF PREFERRED EMBODIMENTS

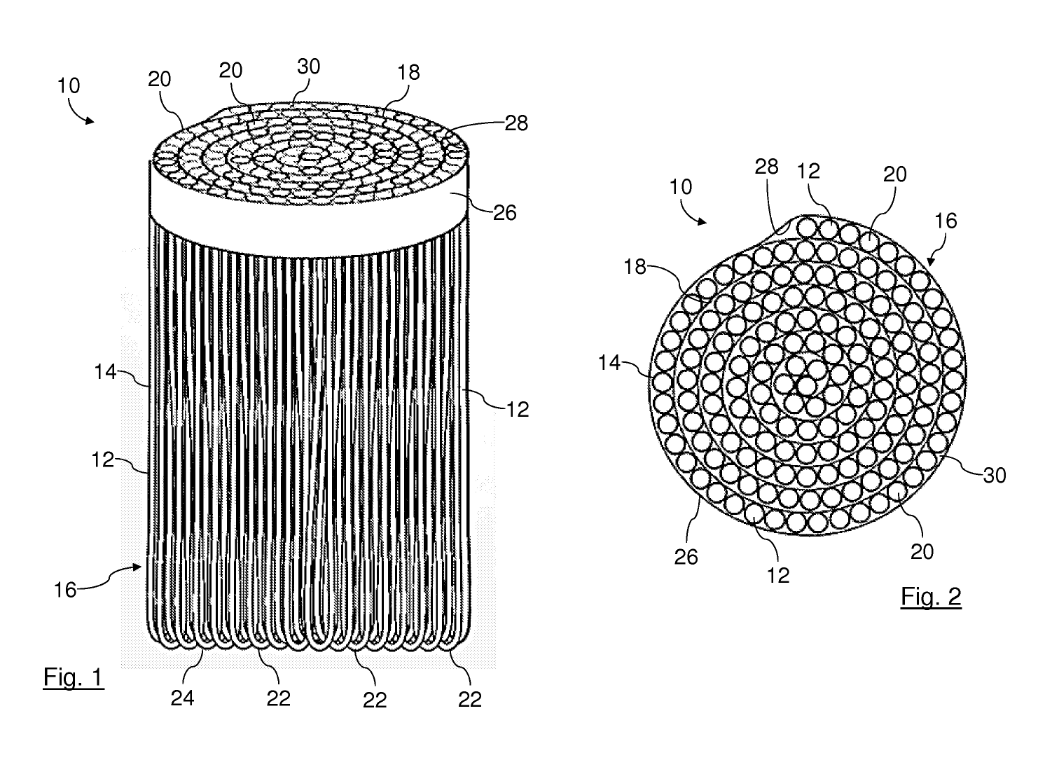

FIGS. 1 and 2 depict a hollow fiber membrane module 10 according to a first embodiment. The hollow fiber membrane module 10 can be used in combination with a fluid treatment device, for example, a fluid filtration unit or a humidifier. Such humidifiers can be used, for example, in combination with fuel cells.

The hollow fiber membrane module 10 comprises a plurality of elongate fiber sections 12 of a hollow fiber membrane 14 arranged as a rolled bundle 16. The bundle 16 has a round cross-section. On a first end face 18 of the bundle 16, the elongate fiber sections 12 are arranged side by side, each having an open end 20. In the area of their open ends 20, the fiber sections 12 are parallel.

On the first end face 18, the interior of the fiber sections 12 can be connected to an inlet or an outlet of the fluid treatment device, for example.

Two elongate fiber sections 12 each have a first end connected with a looped fiber section 22 so as to form together a one-piece (monolithic) member or unit. The unit of two fiber sections 12 and one looped fiber section 22 defines a one-piece fiber part.

The bundle 16 comprises a plurality of such fiber parts. The looped fiber sections 22 are arranged on a second end face 24 of the bundle 16. The second end face 24 of the bundle 16 is opposite the first end face 18.

The fiber sections 12 are secured by a fixing means in the form of a fixing tape or fixing strip 26 at their second open ends 20. One of the long sides of the fixing tape or strip 26 ends flush with the second open ends 20 of the fiber sections 12. Said long side of the at least one fixing tape or strip 26 is aligned with the edges of the open ends 20 of the fiber sections 12. The fixing tape or strip 26 secures the fiber sections 12 up to the edges of the second open ends 20.

The fixing tape or strip 26 is a thin, flexible polymer backing strip. Selection of the material of the fixing tape or strip 26 depends on operating and/or environmental conditions of the hollow fiber membrane module 10, in particular on a product application and/or environment.

The fixing tape 26 has an adhesive side 28. On the adhesive side 28, the fiber sections 12 are fixed.

On the first end face 18 of the bundle 16, the open ends 20 of the fiber sections 12 and the fixing tape or strip 26 are potted in a potting material 30. Interstices between the fiber sections 12 are closed or sealed by the potting material 30.

By use of the potting material 30, the bundle 16 can be attached to the housing of the fluid treatment device, for example.

An exemplary method of forming the hollow fiber membrane module 10 is described in the following.

A one-piece (continuous) hollow fiber membrane 14 is produced and made ready for application.

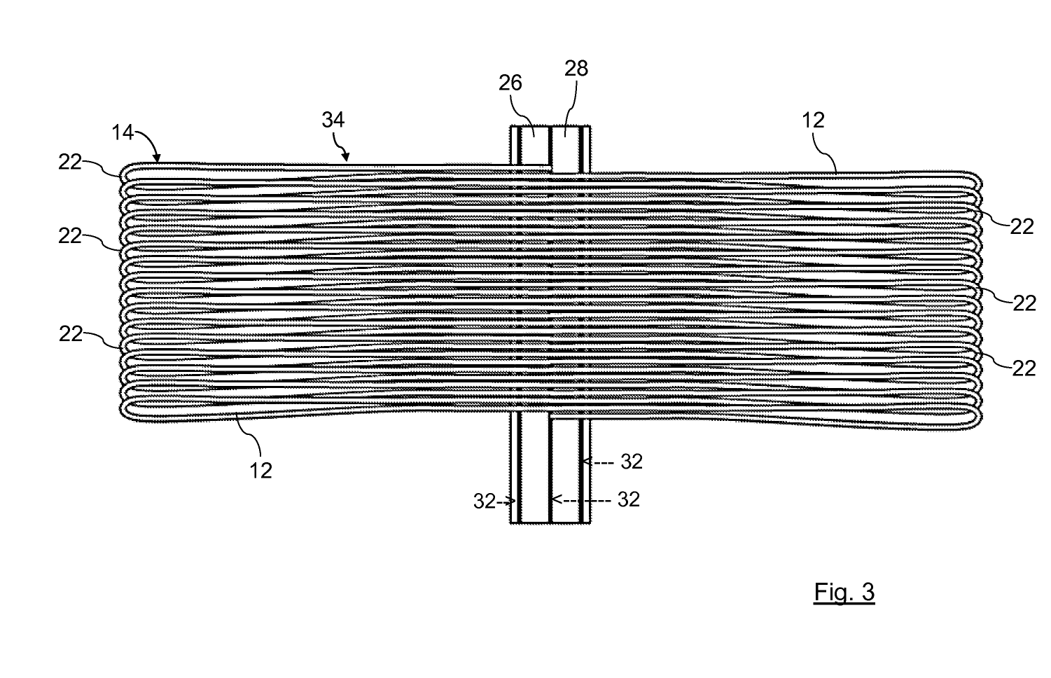

In an exemplary fashion, three small adhesive beads 32, shown in FIG. 3, are applied to the adhesive side 28 of the fixing tape or strip 26. The adhesive beads 32 extend parallel to each other along the length of the fixing tape or strip 26. The material of the adhesive beads 32 is compatible with the potting material 30. The hollow fiber membrane 14 is laid in a continuous fashion by a back and forth folding pattern. In this way, the hollow fiber membrane 14 is laid across the adhesive side 28 of the fixing tape or strip 26. The elongate fiber sections 12 of the hollow fiber membrane 14 are thus arranged in a continuous manner side by side. Adjacent fiber sections 12 are connected by a looped fiber section 22, respectively. The length of the folded hollow fiber membrane 14 is chosen dependent on the length of the final bundle 16 needed for an appropriate housing.

The adhesive beads 32 keep the hollow fiber membrane 14 attached to and aligned on the fixing tape or strip 26. The fiber sections 12 are held in place by the fixing tape or strip 26 as they are being laid. The fixing tape or strip 26 is fixing/securing the elongate fiber sections 12. The hollow fiber membrane 14 with the fixing tape or strip 26 constitutes a hollow fiber sheet 34.

Two large beads of potting material 30 are dispensed onto the adhesive side 28 of the fixing tape or strip 26.

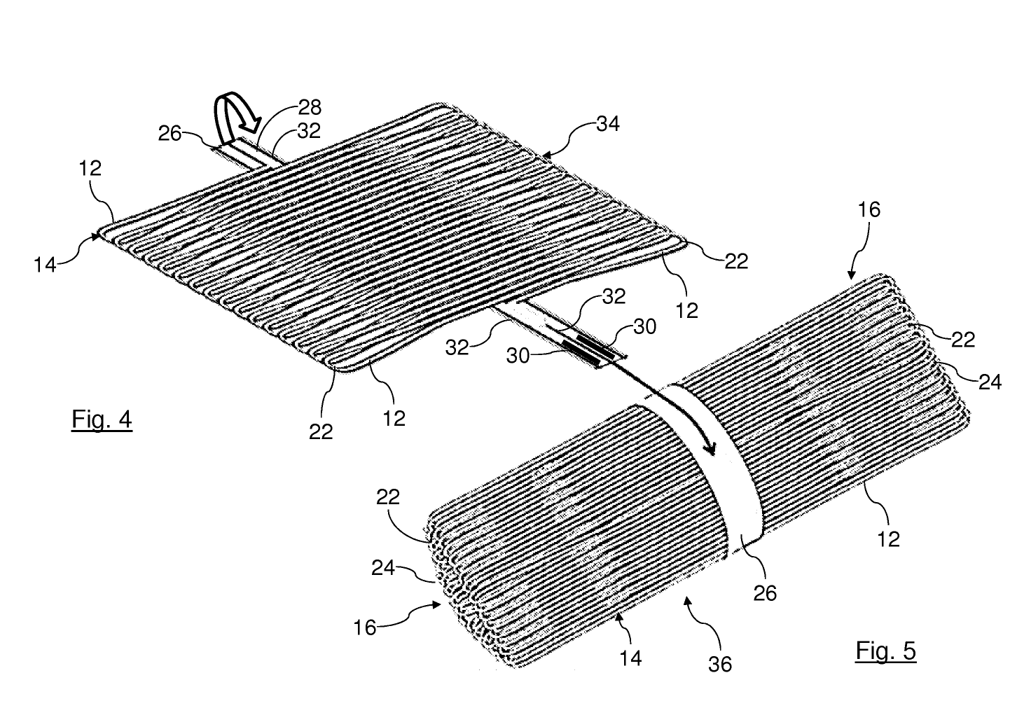

The hollow fiber sheet 34 is rolled in a direction transverse to the elongate fiber sections 12 into a round bundle 36, as shown in FIG. 4. The fixing tape or strip 26 is continued around the bundle 16 to form an outer band. During the rolling process, the potting material 30 is dispensed onto the fixing tape 26. The pressure that is generated during the rolling process distributes the potting material 30 around all areas of the elongate fiber sections 12.

After the potting material 30 has hardened or cured, the bundle 36 of FIG. 5 is cut into two bundles 16 along a centerline of the fixing tape or strip 26. After cutting, the open ends 20 of the fiber sections 12 are exposed (see FIG. 1). The potting material 30 realizes a complete seal at the respective first end face 18 of each of the final bundles 16. The open ends 20 of the elongate fiber sections 12 are potted in the potting material 30. The two bundles 16 according to FIGS. 1 and 2 are ready to be installed and seal in the appropriate housing.

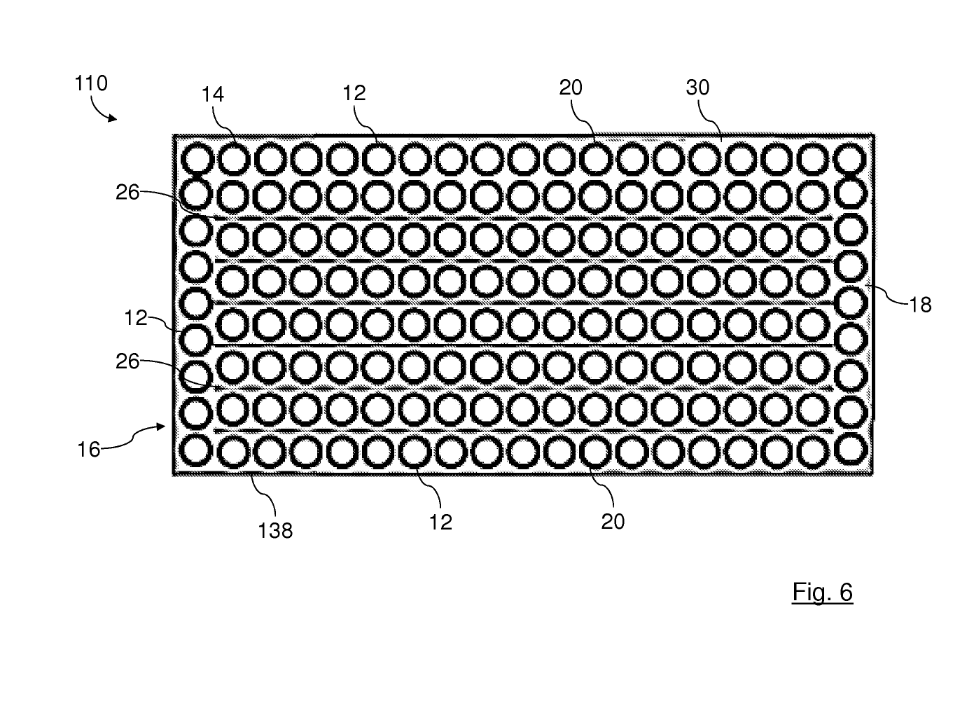

FIG. 6 depicts a second embodiment of a hollow fiber membrane module 110. Those parts which are the same as those of the first embodiment according to FIGS. 1 to 5 have the same reference numbers. In contrast to the first embodiment, the bundle 16 has a rectangular cross-section in the second embodiment.

The rectangular bundle 16 is created by stacking hollow fiber sections backed with strips or tapes 26 and then wrapping with a continuous outer layer 138. The fiber sections 12 and the fixing tapes or strips 26 are layered to form the bundle 16.

While specific embodiments of the invention have been shown and described in detail to illustrate the inventive principles, it will be understood that the invention may be embodied otherwise without departing from such principles.

What is claimed is:

1. A hollow fiber module comprising:
elongate fiber sections arranged to form a bundle, wherein the bundle comprises a first end face;
wherein at least two of said elongate fiber sections are arranged side by side and comprise a first end and a second open end, wherein the first ends are connected to each other by a looped fiber section so that a one-piece fiber part is formed, and wherein the second open ends are arranged at the first end face of the bundle;
at least one fixing strip that secures the second open ends.

2. The hollow fiber module according to claim 1, wherein the at least one fixing strip comprises a polymer.

3. The hollow fiber module according to claim 1, wherein the at least one fixing strip comprises at least one adhesive side.

4. The hollow fiber module according to claim 1, wherein the bundle has a rolled, wound, layered or folded structure at the first end face.

5. The hollow fiber module according to claim 1, wherein the bundle has a round, oval or angular cross-section.

6. The hollow fiber module according to claim 1, wherein the first end face has a round, oval or angular shape.

7. The hollow fiber module according to claim 1, further comprising a potting material provided at the first end face of the bundle, wherein at least one of the second open ends is potted in the potting material.

8. A fluid treatment device comprising a hollow fiber module, wherein the hollow fiber module comprises:
elongate fiber sections arranged to form a bundle, wherein the bundle comprises a first end face;
wherein at least two of said elongate fiber sections are arranged side by side and comprise a first end and a second open end, wherein the first ends are connected to each other by a looped fiber section so that a one-piece fiber part is formed, and wherein the second open ends are arranged at the first end face of the bundle;
at least one fixing strip that secures the second open ends.

9. A method of forming a hollow fiber module, the method comprising the steps of:
placing elongate fiber sections side by side;
securing the elongate fiber sections by at least one fixing strip;
arranging the elongate fiber sections secured by the at least one fixing strip as a bundle;
forming at least one hollow fiber within the bundle as a one-piece fiber part of at least two of said elongate fiber sections connected to each other by at least one looped fiber section.

10. The method according to claim 9, further comprising laying the at least one hollow fiber with a back and forth folding pattern across the at least one fixing strip.

11. The method according to claim 10, further comprising the step of cutting the at least one fixing strip and the at least one hollow fiber along a length of the at least one fixing strip.

12. The method according to claim 9, wherein the step of arranging the fiber sections secured to the at least one fixing strip as a bundle comprises rolling or winding or layering.

13. The method according to claim 9, further comprising potting at least one open end of at least one of the fiber sections in a potting material at least on a first end face of the bundle.
